(19) United States
(12) Patent Application Publication
(10) Pub. No.: US 2026/0220091 A1
(43) Pub. Date: Jul. 30, 2026

(54) IDENTIFYING DUPLICATE SEGMENTS AND THE LATEST SEGMENT USING A LIVE INSTANCE FILTER

(71) Applicant: Dell Products L.P., Round Rock, TX (US)

(72) Inventors: Srikanth Srinivasan, Bangalore (IN); Chuanbo Jack Zheng, Cupertino, CA (US); Heta Saraiya, Livermore, CA (US); Pavitra Haveri, Dharwad, IN (US); Kalyani Sundaralingam, Campbell, CA (US); Xiaobing Zhang, Saratoga, CA (US)

(21) Appl. No.: 19/036,554

(22) Filed: Jan. 24, 2025

(51) Int. Cl. G06F 16/174; G06F 16/13; G06F 16/16

(52) U.S. Cl. CPC G06F 16/1748; G06F 16/137; G06F 16/162

(57) ABSTRACT

A method for managing data in a storage system includes: adding identifier information to fingerprints to obtain suffixed fingerprints; lexicographically sorting the suffixed fingerprints to obtain a sorted index; bucketizing the suffixed fingerprints in the sorted list to obtain a set of buckets; checking, for each bucket, if the suffixed fingerprint is live; determining if the container identification (CID) associated with the suffixed fingerprint is higher than a stored fingerprint in a live filter; and based on the determination, storing the suffixed fingerprint in a live instance filter and making available for garbage collection.

### BACKGROUND

Devices often struggle with identifying duplicate segments in a filesystem. In such scenarios, it may be desirable to adapt one or more systems to enhance the identification functionalities of devices that cannot efficiently perform those functionalities.

### BRIEF DESCRIPTION OF DRAWINGS

Certain embodiments disclosed herein will be described with reference to the accompanying drawings. However, the accompanying drawings illustrate only certain aspects or implementations of one or more embodiments disclosed herein by way of example and are not meant to limit the scope of the claims.

FIG. 1 shows a diagram of a system in accordance with one or more embodiments disclosed herein.

FIG. 2 shows an example segment tree in accordance with one or more embodiments disclosed herein.

FIG. 3 shows an example segment dataset bucketization in accordance with one or more embodiments disclosed herein.

FIG. 4.1 shows a diagram of a container data structure in accordance with one or more embodiments disclosed herein.

FIG. 4.2 shows a diagram of a compression region in accordance with one or more embodiments disclosed herein.

FIG. 5 shows a diagram of a manager in accordance with one or more embodiments disclosed herein.

FIG. 6 shows a method for bucketizing suffixed fingerprints in accordance with one or more embodiments disclosed herein.

FIG. 7 shows a method for storing fingerprints in to a live instance filter in accordance with one or more embodiments disclosed herein.

FIG. 8.1 shows an example of lexicographical sorting in accordance with one or more embodiments disclosed herein.

FIG. 8.2 shows an example of liveness filtering in accordance with one or more embodiments disclosed herein.

FIG. 9 shows a diagram of a computing device in accordance with one or more embodiments disclosed herein.

### DETAILED DESCRIPTION

Specific embodiments disclosed herein will now be described in detail with reference to the accompanying figures. In the following detailed description of the embodiments disclosed herein, numerous specific details are set forth in order to provide a more thorough understanding of one or more embodiments disclosed herein. However, it will be apparent to one of ordinary skill in the art that the one or more embodiments disclosed herein may be practiced without these specific details. In other instances, well-known features have not been described in detail to avoid unnecessarily complicating the description.

In the following description of the figures, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment, which may be implemented in addition to, in conjunction with, or in place of the embodiments described with regard to a corresponding like-named component in any other figure.

Throughout this application, elements of figures may be labeled as A to N. As used herein, the aforementioned labeling means that the element may include any number of items, and does not require that the element include the same number of elements as any other item labeled as A to N. For example, a data structure may include a first element labeled as A and a second element labeled as N. This labeling convention means that the data structure may include any number of the elements. A second data structure, also labeled as A to N, may also include any number of elements. The number of elements of the first data structure, and the number of elements of the second data structure, may be the same or different.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase “operatively connected” may refer to any direct connection (e.g., wired directly between two devices or components) or indirect connection (e.g., wired and/or wireless connections between any number of devices or components connecting the operatively connected devices). Thus, any path through which information may travel may be considered an operative connection.

In general, a file system of a distributed dedupe storage system uses a segregated architecture to store metadata and/or data associated with each asset (e.g., a file, a folder, etc.). In a distributed dedupe storage system, files may be stored as a segment tree where the lowest level of the tree may be a hash of data (e.g., user data, application data, etc.), and the intermediate levels of the tree may be hashes of its child nodes (e.g., child segments). When multiple segments exist which contain identical information, the storage of such duplicative information may consume more computing/storage resources than necessary.

While no solutions/approaches exist for distributed dedupe storage systems (for at least the aforementioned issue(s)), some of the existing solutions try to detect duplicate segments in a given storage system through a two pass filter. In the traditional approach two filters are used: a live filter and a live instance filter. The live filter is used to determine which segments (identified using fingerprints) are live, where the result of the first filtration is a live index. The second filtration uses the live instance filter to determine the most recent live segment from the live index. This approach consumes twice the memory and twice the time to complete as it requires two similarly sized filters working sequentially to identify the live and dead segments in the storage. The limitations with this approach are further exacerbated when then segments are stored in a distributed storage where duplicate copies of a segment may be located on different storage (also referred to as storage devices). Accordingly, the above approach cannot identify live and dead segments nor the most recent live segment in a single pass within a distributed storage system.

For at least the reasons discussed above and without requiring resource-intensive efforts (e.g., time, engineering, etc.), a fundamentally different approach/framework is needed (e.g., an approach for storage systems (especially for distributed dedupe storage systems) to (i) verify the currentness of all files (in the storage system), (ii) identify duplicate segments in a single pass, and (iii) mark all duplicates as available for garage collection.

Embodiments disclosed herein relate to methods and systems to manage data in a storage system/platform. As a result of the processes discussed below, one or more embodiments disclosed herein advantageously ensure that: (i) the framework adds identifier information to fingerprints to obtain suffixed fingerprints; (ii) the framework lexicographically sorts the suffixed fingerprints to obtain a sorted index; (iii) the framework bucketizes the suffixed fingerprints in the sorted list to obtain a set of buckets; (iv) the framework checks, for each bucket, if the suffixed fingerprint is live; (v) the framework determines if the container identification (CID) associated with the suffixed fingerprint is higher than a stored fingerprint in a live filter; and (vi) based on the determination, the framework stores the suffixed fingerprint in a live instance filter or makes available for garbage collection.

By lexicographically sorting the suffixed fingerprints all duplicate copies of a given segment are clustered together. Further, the bucketization discussed below guarantees that all copies of given segment are stored in a single bucket. As a result, once a bucket is processed, embodiments of the invention guarantee that all duplicates of the segment have been identified. Further, because all copies of a given segment are in a bucket, the buckets may be processed in parallel, which further decreases the time required to identify the segments that need to be garbage collected.

The following describes various embodiments disclosed herein.

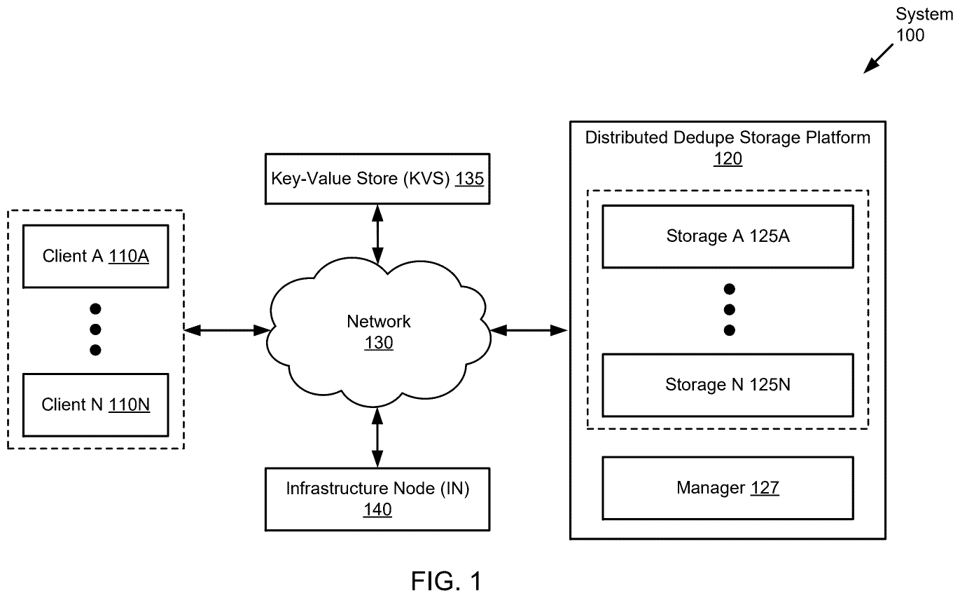

FIG. 1 shows a diagram of a system (100) in accordance with one or more embodiments disclosed herein. The system (100) includes any number of clients (e.g., Client A (110A), Client N (110N), etc.), a distributed dedupe storage platform (120), a network (130), a key-value store (KVS) (135), and an infrastructure node (IN) (140). The system (100) may include additional, fewer, and/or different components without departing from the scope of the embodiments disclosed herein. Each component may be operably/operatively connected to any of the other components via any combination of wired and/or wireless connections. Each component illustrated in FIG. 1 is discussed below.

In one or more embodiments, the clients (e.g., 110A, 110N, etc.), the KVS (135), the IN (140), the distributed dedupe storage platform (120), and the network (130) may be (or may include) physical hardware or logical devices, as discussed below. While FIG. 1 shows a specific configuration of the system (100), other configurations may be used without departing from the scope of the embodiments disclosed herein. For example, although the clients (e.g., 110A, 110N, etc.) and the IN (140) are shown to be operatively connected through a communication network (e.g., 130), the clients (e.g., 110A, 110N, etc.) and the IN (140) may be directly connected (e.g., without an intervening communication network).

Further, the functioning of the clients (e.g., 110A, 110N, etc.) and the IN (140) is not dependent upon the functioning and/or existence of the other components (e.g., devices) in the system (100). Rather, the clients and the IN may function independently and perform operations locally that do not require communication with other components. Accordingly, embodiments disclosed herein should not be limited to the configuration of components shown in FIG. 1.

As used herein, “communication” may refer to simple data passing, or may refer to two or more components coordinating a job. As used herein, the term “data” is intended to be broad in scope. In this manner, that term embraces, for example (but not limited to): a data stream (or stream data), data chunks, data blocks, atomic data, emails, objects of any type, files of any type (e.g., media files, spreadsheet files, database files, etc.), contacts, directories, sub-directories, volumes, etc.

In one or more embodiments, although terms such as “document”, “file”, “segment”, “block”, or “object” may be used by way of example, the principles of the present disclosure are not limited to any particular form of representing and storing data or other information. Rather, such principles are equally applicable to any object capable of representing information.

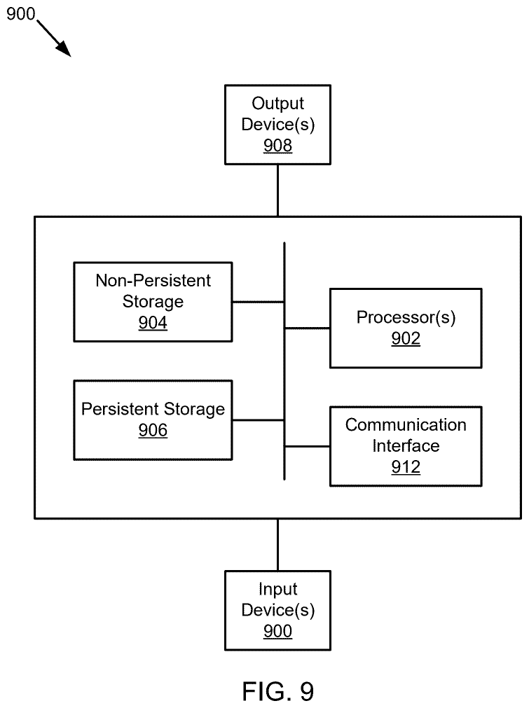

In one or more embodiments, the system (100) may be a distributed system (e.g., a data processing environment) and may deliver at least computing power (e.g., real-time (on the order of milliseconds (ms) or less), network monitoring, server virtualization, data deduplication performed by a manager (127) of the storage platform (120), etc.), storage capacity (e.g., to store encrypted data across storage nodes (e.g., 125A, 125N, etc.) of the storage platform (120)), and data protection (e.g., software-defined data protection, disaster recovery, etc.) as a service to users (e.g., people) of clients (e.g., 110A, 110N, etc.). For example, the system may be configured to organize unbounded, continuously generated data into a data stream. The system (100) may also represent a comprehensive middleware layer executing on computing devices (e.g., 900, FIG. 9) that supports application and storage environments.

In one or more embodiments, the system (100) may support one or more virtual machine (VM) environments, and may map capacity requirements (e.g., computational load, storage access, etc.) of VMs and supported applications to available resources (e.g., processing resources, storage resources, etc.) managed by the environments. Further, the system (100) may be configured for workload placement collaboration and computing resource (e.g., processing, storage/memory, virtualization, networking, etc.) exchange.

To provide computer-implemented services to the users, the system (100) may perform some computations (e.g., data collection, distributed processing of collected data, etc.) locally (e.g., at the users'site using the clients (e.g., 110A, 110N, etc.)) and other computations remotely (e.g., away from the users'site using the IN (140)) from the users. By doing so, the users may utilize different computing devices (e.g., 900, FIG. 9) that have different quantities of computing resources (e.g., processing cycles, memory, storage, etc.) while still being afforded consistent user experience. For example, by performing some computations remotely, the system (100) (i) may maintain the consistent user experience provided by different computing devices even when the different computing devices possess different quantities of computing resources, and (ii) may process data more efficiently in a distributed manner by avoiding the overhead associated with data distribution and/or command and control via separate connections.

As used herein, “computing” refers to any operations that may be performed by a computer, including (but not limited to): computation, data storage, data retrieval, communications, etc. Further, as used herein, a “computing device” refers to any device in which a computing operation may be carried out. A computing device may be, for example (but not limited to): a compute component, a storage component, a network device, a telecommunications component, etc.

As used herein, a “resource” refers to any program, application, document, file, asset, executable program file, desktop environment, computing environment, or other resource made available to, for example, a user/customer of a client (described below). The resource may be delivered to the client via, for example (but not limited to): conventional installation, a method for streaming, a VM executing on a remote computing device, execution from a removable storage device connected to the client (such as universal serial bus (USB) device), etc.

In one or more embodiments, a client (e.g., 110A, 110N, etc.) may include functionality to, e.g.,: (i) capture sensory input (e.g., sensor data) in the form of text, audio, video, touch or motion, (ii) collect massive amounts of data at the edge of an Internet of Things (IoT) network (where, the collected data may be grouped as: (a) data that needs no further action and does not need to be stored, (b) data that should be retained for later analysis and/or record keeping, and (c) data that requires an immediate action/response), (iii) provide to other entities (e.g., the IN (140)), store, or otherwise utilize captured sensor data (and/or any other type and/or quantity of data), and (iv) provide surveillance services (e.g., determining object-level information, performing face recognition, etc.) for scenes (e.g., a physical region of space). One of ordinary skill will appreciate that the client may perform other functionalities without departing from the scope of the embodiments disclosed herein.

In one or more embodiments, the clients (e.g., 110A, 110N, etc.) may be physical or logical computing devices configured for hosting one or more workloads, or for providing a computing environment whereon workloads may be implemented. The clients may provide computing environments that are configured for, at least: (i) workload placement collaboration, (ii) computing resource (e.g., processing, storage/memory, virtualization, networking, etc.) exchange, and (iii) protecting workloads (including their applications and application data) of any size and scale (based on, for example, one or more service level agreements (SLAs) configured by users of the clients). The clients (e.g., 110A, 110N, etc.) may correspond to computing devices that one or more users use to interact with one or more components of the system (100).

In one or more embodiments, a client (e.g., 110A, 110N, etc.) may represent a physical appliance or a computing device operated by one or more individuals of (or employed by) an organization. Examples of said individual(s) may include, but not limited to, any organization executive(s) (e.g., chief executive officer (CEO), chief financial officer (CFO), etc.), and any employee(s) in the accounting/finance team of the organization (e.g., a collector person). Further, the organization may refer to any enterprise at least engaged in for-profit commercial, industrial, or professional activities.

In one or more embodiments, a client (e.g., 110A, 110N, etc.) may include any number of applications (and/or content accessible through the applications) that provide computer-implemented services to a user. Applications may be designed and configured to perform one or more functions instantiated by a user of the client. In order to provide application services, each application may host similar or different components. The components may be, for example (but not limited to): instances of databases, instances of email servers, etc. Applications may be executed on one or more clients as instances of the application.

In one or more embodiments, while performing, for example, one or more operations requested by a user, applications installed on a client (e.g., 110A, 110N, etc.) may include functionality to request and use physical and logical resources of the client. Applications may also include functionality to use data stored in storage/memory resources of the client. The applications may perform other types of functionalities not listed above without departing from the scope of the embodiments disclosed herein. While providing application services to a user, applications may store data that may be relevant to the user in storage/memory resources of the client.

In one or more embodiments, to provide services to the users, the clients (e.g., 110A, 110N, etc.) may utilize, rely on, or otherwise cooperate with the IN (140) and/or the distributed dedupe storage platform (120). For example, the clients may issue requests to the IN to receive responses and interact with various components of the IN. The clients may also request data from and/or send data to the IN (for example, the clients may transmit information to the IN that allows the IN to perform computations, the results of which are used by the clients to provide services to the users). As yet another example, the clients may utilize computer-implemented services provided by the IN. When the clients interact with the IN, data that is relevant to the clients may be stored (temporarily or permanently) in the IN.

In one or more embodiments, the client (e.g., 110A, 110N, etc.) may be capable of, e.g.,: (i) collecting users'inputs, (ii) correlating collected users'inputs to the computer-implemented services to be provided to the users, (iii) communicating with the IN (140) and/or the distributed dedupe storage platform (120) that perform computations necessary to provide the computer-implemented services, (iv) using the computations performed by, for example, the IN to provide the computer-implemented services in a manner that appears (to the users) to be performed locally to the users, and/or (v) communicating with any virtual desktop (VD) in a virtual desktop infrastructure (VDI) environment (or a virtualized architecture) provided by the IN (using any known protocol in the art), for example, to exchange remote desktop traffic or any other regular protocol traffic (so that, once authenticated, users may remotely access independent VDs).

As described above, the clients (e.g., 110A, 110N, etc.) may provide computer-implemented services to users (and/or other computing devices). The clients may provide any number and any type of computer-implemented services. To provide computer-implemented services, each client may include a collection of physical components (e.g., processing resources, storage/memory resources, networking resources, etc.) configured to perform operations of the client and/or otherwise execute a collection of logical components (e.g., virtualization resources) of the client.

In one or more embodiments, a processing resource (not shown) may refer to a measurable quantity of a processing-relevant resource type, which can be requested, allocated, and consumed. A processing-relevant resource type may encompass a physical device (i.e., hardware), a logical intelligence (i.e., software), or a combination thereof, which may provide processing or computing functionality and/or services. Examples of a processing-relevant resource type may include (but not limited to): a central processing unit (CPU), a graphics processing unit (GPU), a data processing unit (DPU), a computation acceleration resource, an application-specific integrated circuit (ASIC), a digital signal processor for facilitating high speed communication, etc.

In one or more embodiments, a storage or memory resource (not shown) may refer to a measurable quantity of a storage/memory-relevant resource type, which can be requested, allocated, and consumed (for example, to store sensor data and provide previously stored data). A storage/memory-relevant resource type may encompass a physical device, a logical intelligence, or a combination thereof, which may provide temporary or permanent data storage functionality and/or services. Examples of a storage/memory-relevant resource type may be (but not limited to): a hard disk drive (HDD), a solid-state drive (SSD), random access memory (RAM), Flash memory, a tape drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, virtualized memory, etc.

In one or more embodiments, while the clients (e.g., 110A, 110N, etc.) provide computer-implemented services to users, the clients may store data that may be relevant to the users to the storage/memory resources. When the user-relevant data is stored (temporarily or permanently), the user-relevant data may be subjected to loss, inaccessibility, or other undesirable characteristics based on the operation of the storage/memory resources.

In one or more embodiments, a client (e.g., 110A, 110N, etc.) may be, for example (but not limited to): a physical computing device, a smartphone, a tablet, a wearable, a gadget, a closed-circuit television (CCTV) camera, a music player, a game controller, etc. Different clients may have different computational capabilities.

Further, in one or more embodiments, a client (e.g., 110A, 110N, etc.) may be implemented as a computing device (e.g., 900, FIG. 9). The computing device may be, for example, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the client described throughout the application.

Alternatively, in one or more embodiments, the client (e.g., 110A, 110N, etc.) may be implemented as a logical device (e.g., a VM). The logical device may utilize the computing resources of any number of computing devices to provide the functionality of the client described throughout this application.

In one or more embodiments, the IN (140) may include (i) a chassis (e.g., a mechanical structure, a rack mountable enclosure, etc.) configured to house one or more servers (or blades) and their components and (ii) any instrumentality or aggregate of instrumentalities operable to compute, classify, process, transmit, receive, retrieve, originate, switch, store, display, manifest, detect, record, reproduce, handle, and/or utilize any form of data for business, management, entertainment, or other purposes.

In one or more embodiments, the IN (140) may include functionality to, e.g.,: (i) obtain (or receive) data (e.g., any type and/or quantity of input) from any source (and, if necessary, aggregate the data); (ii) perform complex analytics and analyze data that is received from one or more clients (e.g., 110A, 110N, etc.) to generate additional data that is derived from the obtained data without experiencing any middleware and hardware limitations; (iii) provide meaningful information (e.g., a response) back to the corresponding clients; (iv) filter data (e.g., received from a client) before pushing the data (and/or the derived data) to the distributed dedupe storage platform (120) for management of the data and/or for storage of the data (while pushing the data, the IN may include information regarding a source of the data (e.g., an identifier of the source) so that such information may be used to associate provided data with one or more of the users (or data owners)); (v) host and maintain various workloads; (vi) provide a computing environment whereon workloads may be implemented (e.g., employing linear, non-linear, and/or machine learning (ML) models to perform cloud-based data processing); (vii) incorporate strategies (e.g., strategies to provide VDI capabilities) for remotely enhancing capabilities of the clients; (viii) provide robust security features to the clients and make sure that a minimum level of service is always provided to a user of a client; (ix) transmit the result(s) of the computing work performed (e.g., real-time business insights, equipment maintenance predictions, other actionable responses, etc.) to another IN (not shown) for review and/or other human interactions; (x) exchange data with other devices registered in/to the network (130) in order to, for example, participate in a collaborative workload placement (e.g., the node may split up a request (e.g., an operation, a task, an activity, etc.) with another IN, coordinating its efforts to complete the request more efficiently than if the IN had been responsible for completing the request); (xi) provide (in conjunction with the distributed dedupe storage platform (120)) software-defined data protection for the clients (e.g., 110A, 110N, etc.); (xii) provide (in conjunction with the distributed dedupe storage platform (120)) automated data discovery, protection, management, and recovery operations for the clients; (xiii) monitor operational states of the clients; (xiv) regularly back up configuration information of the clients to the distributed dedupe storage platform (120); (xv) provide (e.g., via a broadcast, multicast, or unicast mechanism) information (e.g., a location identifier, the amount of available resources, etc.) associated with the IN to other INs of the system (100); (xvi) configure or control any mechanism that defines when, how, and what data to provide to the clients and/or distributed dedupe storage platform; (xvii) provide data deduplication (in conjunction with the distributed dedupe storage platform (120)); (xviii) orchestrate (in conjunction with the distributed dedupe storage platform (120)) data protection through one or more GUIs; (xix) empower data owners (e.g., users of the clients) to perform self-service data backup and restore operations from their native applications (in conjunction with the distributed dedupe storage platform (120)); (xx) ensure compliance and satisfy different types of service level objectives (SLOs) set by an administrator/user; (xxi) increase (in conjunction with the distributed dedupe storage platform (120)) resiliency of an organization by enabling rapid recovery or cloud disaster recovery from cyber incidents ; (xxii) provide operational simplicity, agility, and flexibility for physical, virtual, and cloud-native environments; (xxiii) consolidate multiple data process or protection requests (received from, for example, clients) so that duplicative operations (which may not be useful for restoration purposes) are not generated; (xxiv) initiate multiple data process or protection operations in parallel (e.g., an IN may host multiple operations, in which each of the multiple operations may (a) manage the initiation of a respective operation and (b) operate concurrently to initiate multiple operations); and/or (xxv) manage operations of one or more clients (e.g., receiving information from the clients regarding changes in the operation of the clients) to improve their operations (e.g., improve the quality of data being generated, decrease the computing resources cost of generating data, etc.). In one or more embodiments, in order to read, write, or store data, the IN (140) may communicate with, for example, the distributed dedupe storage platform (120) and/or other storage devices in the system (100).

As described above, the IN (140) may be capable of providing a range of functionalities/services to the users of the clients (e.g., 110A, 110N, etc.). However, not all users may be allowed to receive all the services. To manage the services provided to the users of the clients, a system (e.g., a service manager) in accordance with embodiments disclosed herein may manage the operation of a network (e.g., 130), in which the clients are operably connected to the IN. Specifically, the service manager (i) may identify services to be provided by the IN (for example, based on the number of users using the clients) and (ii) may limit communications of the clients to receive IN provided services.

As used herein, a “workload” is a physical or logical component configured to perform certain work functions. Workloads may be instantiated and operated while consuming computing resources allocated thereto. A user may configure a data protection policy for various workload types. Examples of a workload may include (but not limited to): a data protection workload, a VM, a container, a network-attached storage (NAS), a database, an application, a collection of microservices, a file system (FS), small workloads with lower priority workloads (e.g., FS host data, operating system (OS) data, etc.), medium workloads with higher priority (e.g., VM with FS data, network data management protocol (NDMP) data, etc.), large workloads with critical priority (e.g., mission critical application data), etc.

As used herein, a “policy” is a collection of information, such as a backup policy or other data protection policy, that includes, for example (but not limited to): identity of source data that is to be protected, backup schedule and retention requirements for backed up source data, identity of a service level agreement (SLA) (or a rule) that applies to source data, identity of a target device where source data is to be stored, etc.

As used herein, the term “backup” is intended to be broad in scope. In this manner, example backups in connection with which embodiments disclosed herein may be employed include (but not limited to): full backups, partial backups, clones, snapshots, incremental backups, differential backups, etc.

As used herein, a “rule” is a guideline used by an SLA component to select a particular target device (or target devices), based on the ability of the target device to meet requirements imposed by the SLA. For example, a rule may specify that an HDD having a particular performance parameter should be used as the target device. A target device selected by the SLA component may be identified as part of a backup policy or other data protection policy.

As used herein, a “file system” is a method that an OS is used to control how data is named, stored, and retrieved. For example, once a user has logged into a computing device (e.g., 900, FIG. 9), the OS of that computing device uses the file system (e.g., new technology file system (NTFS), a resilient file system (ReFS), a third extended file system (ext3), etc.) of that computing device to retrieve one or more applications to start performing one or more operations (e.g., functions, tasks, activities, jobs, etc.). As yet another example, a file system may divide a volume (e.g., a logical drive) into a fixed group of bytes to generate one or more blocks of the volume.

As used herein, a “volume” may be analogous to a logical unit number in a storage area network (SAN), in which a volume may be a subset of the distributed dedupe storage platform's (120) capacity presented by a storage node (e.g., 125A, 125N, etc.) as a local block device. A volume's data may be evenly distributed across all storage resources of the distributed dedupe storage platform (120), for example, according to a data layout selected for the distributed dedupe storage platform (120).

Further, while a single IN (e.g., 140) is considered above, the term “node” includes any collection of systems or sub-systems that individually or jointly execute a set, or multiple sets, of instructions to provide one or more computer-implemented services. For example, a single IN/server/host may provide a computer-implemented service on its own (i.e., independently) while multiple other nodes may provide a second computer-implemented service cooperatively (e.g., each of the multiple other nodes may provide similar and or different services that form the cooperatively provided service).

As described above, the IN (140) may provide any quantity and any type of computer-implemented services. To provide computer-implemented services, the IN may be a heterogeneous set, including a collection of physical components/resources (discussed above) configured to perform operations of the node and/or otherwise execute a collection of logical components/resources (discussed above) of the node.

In one or more embodiments, the IN (140) may implement a management model to manage the aforementioned computing resources in a particular manner. The management model may give rise to additional functionalities for the computing resources. For example, the management model may automatically store multiple copies of data in multiple locations when a single write of the data is received. By doing so, a loss of a single copy of the data may not result in a complete loss of the data. Other management models may include, for example, adding additional information to stored data to improve its ability to be recovered, methods of communicating with other devices to improve the likelihood of receiving the communications, etc. Any type and number of management models may be implemented to provide additional functionalities using the computing resources without departing from the scope of the embodiments disclosed herein.

One of ordinary skill will appreciate that the IN (140) may perform other functionalities without departing from the scope of the embodiments disclosed herein.

In one or more embodiments, the IN (140) may be implemented as a computing device (e.g., 900, FIG. 9). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the IN described throughout the application.

Alternatively, in one or more embodiments, similar to a client (e.g., 110A, 110N, etc.), the IN (140) may also be implemented as a logical device.

In the embodiments of the present disclosure, the KVS (135) (e.g., a key-value database) is demonstrated as a separate entity from the distributed dedupe storage platform (120); however, embodiments disclosed herein are not limited as such. The KVS (135) may be demonstrated as part of the distributed dedupe storage platform (e.g., as deployed to the platform, a sub-component within the platform, etc.).

In one or more embodiments, users (e.g., customers, administrators, people, etc.) and/or the distributed dedupe storage platform (120) may utilize the KVS (135) (for example, as an external/remote key-value manager) to generate, store, transmit, and/or delete keys (e.g., to perform key related operations) because (i) an external key-value manager may be more secure (which makes it much harder to covertly discover cryptographic keys) for generating, storing, transmitting, and/or deleting (e.g., forgetting, discarding, etc.) cryptographic keys than a data storage system and (ii) an external key-value manager is typically a fairly simple, self-contained system that is not downloading potentially malicious applications (e.g., software).

In one or more embodiments, the KVS (135) may refer to a data storage method that stores objects (e.g., metadata segments, application deployment information, API calls used to extract application deployment information, etc.) and associated keys. The keys may refer to hashes, numbers, and/or identifiers, which may be associated with particular objects stored to the KVS (135). In one or more embodiments, one or more keys may be used to quickly retrieve one or more objects (e.g., values associated with the keys) stored to the KVS (135).

In one or more embodiments, as being an external cryptographic key-value manager (remote to the distributed dedupe storage platform (120)), the KVS (135) may include a random number generator to generate cryptographic keys (e.g., encryption keys, decryption keys, etc.) for use (i) in encrypting data items for storage in a storage node (e.g., 125A, 125N, etc.) or (ii) in decrypting data items for retrieval from the corresponding drive of a storage node.

As described above, the KVS (135) may generate, store, transmit, and/or delete one or more keys for one or more volumes/drives of a storage node (e.g., 125A, 125N, etc.). Each key stored on the KVS (135) may be associated with a particular volume (e.g., a per-logical-volume key). In one or more embodiments, the KVS (135) may store a single key, as well as two or more keys (in which a second key may be generated by a KVS (not shown) and transmitted to the KVS (135) for storage). The KVS (135) may also store one or more keys for each volume. In other words, the distributed dedupe storage platform (120) may store multiple keys for a volume on the KVS (135) (which is coupled to the distributed dedupe storage platform (120)).

As used herein, “data item” is intended to be broadly construed to encompass, for example, a block, a chunk, file, object, or other grouping of data suitable for storage in the distributed dedupe storage platform (120).

As used herein, “encryption” (e.g., a symmetric or asymmetric encryption) is the process of encoding data based on a cryptographic key (e.g., the process of applying a model to a data chunk (e.g., a segment) using an encryption key to generate an encrypted data chunk). In this manner, only an authorized user/party having the appropriate cryptographic key is able to decrypt the data. An unauthorized user/party intercepting the encrypted data is unable to read or utilize the encoded data without the appropriate key. In one or more embodiments, a data encryption/decryption operation may be performed according to different cryptographic modes/models, for example (but not limited to): a cipher block chaining (CBC) mode, a ciphertext stealing (XTS) mode, a Galois/Counter Mode (GCM), etc.

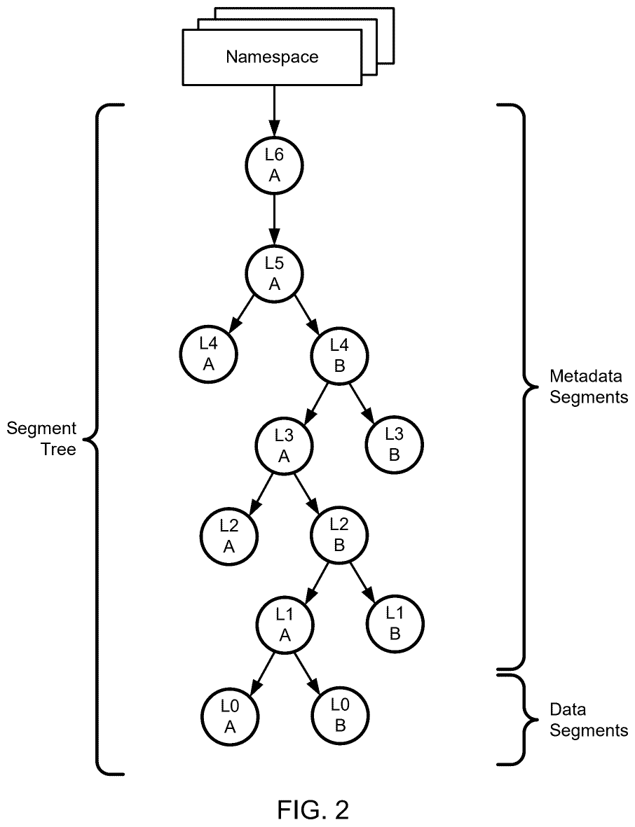

In one or more embodiments, the KVS (135) may further include functionality to, e.g.,: (i) reliably discard (or delete) one or more child segments (stored as “values” or “child entries”) referenced/pointed by a related parent segment (stored as a “key” or a “parent entry”); (ii) store one or more metadata segments of a segment tree (see FIG. 2); (iii) perform data protection related (or key related) operations (e.g., key management operations, key policy operations, key introduction operations, re-keying operations, managing existing keys, deleting older keys, etc.), in which (a) the key related operations may be used to manage how data is encrypted or decrypted, (b) the associated policies may determine when keys are introduced, how many keys are allowed, when data is rekeyed, and the like, and (c) the aforementioned operations may be independent of each other and may be performed asynchronously or synchronously; and/or (iii) include a module that perform the aforementioned operations using resources that are available (e.g., not being used by another workload) in the KVS (135), in which by using the available resources (or performing these operations in the background), the module may avoid having to specifically allocate resources to the operations that could impact the performance of other workloads. One of ordinary skill will appreciate that the KVS (135) may perform other functionalities without departing from the scope of the embodiments disclosed herein.

In one or more embodiments, the KVS (135) may be implemented as a computing device (e.g., 900, FIG. 9). The computing device may be, for example, a mobile phone, a tablet computer, a laptop computer, a desktop computer, a server, a distributed computing system, or a cloud resource. The computing device may include one or more processors, memory (e.g., RAM), and persistent storage (e.g., disk drives, SSDs, etc.). The computing device may include instructions, stored in the persistent storage, that when executed by the processor(s) of the computing device cause the computing device to perform the functionality of the KVS described throughout the application.

Alternatively, in one or more embodiments, similar to a client (e.g., 110A, 110N, etc.), the KVS (135) may also be implemented as a logical device.

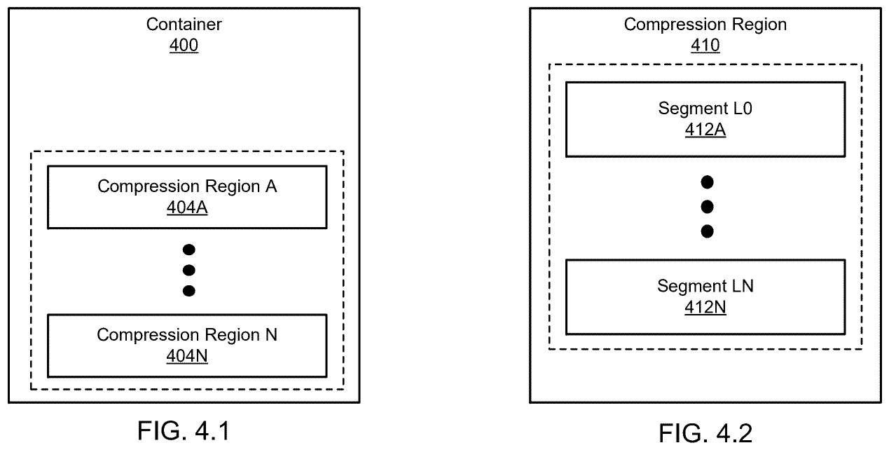

In one or more embodiments, the distributed dedupe storage platform (120) may be a scale-out storage platform (e.g., a storage cluster) that includes/hosts, at least, the manager (127) and any number of storage nodes (e.g., Storage Node A (125A), Storage Node N (125N), etc.). In one or more embodiments, the storage nodes (e.g., Storage node A (125A), Storage Node N (125N), etc.) include containers (FIG. 4.1).

In one or more embodiments, a storage node (e.g., 125A, 125N, etc.) may provide less, the same, or more functionalities and/or services (described above) compared to the IN (140). A software service/application may be installed/deployed (by a related user) to a node/server so that the node can be turned into a storage node (e.g., 125A, 125N, etc.) that contributes disks to the distributed dedupe storage platform (120). Working together, several storage nodes (e.g., 125A, 125N, etc.) may abstract local storage (e.g., object storage, block storage, etc.) and present volumes to the clients (e.g., 110A, 110N, etc.). Further, each software service may leverage storage resources (e.g., SSDs, storage class memory, spinning disk media, available RAM, etc.) of a corresponding “storage” node, and each storage node (e.g., 125A, 125N, etc.) may be a fault unit.

Referring to FIG. 1, (i) Storage Node A (125A) may be part of a first business operation region (BOR) and may execute on a first geographic location in the world and (ii) Storage Node N (125N) may be part of a second BOR and may execute on a second geographic location in the world, in which the first geographic location and the second geographic location may be distinct locations.

In one or more embodiments, as being a log-structured storage platform that processes incoming data from, for example, the clients (e.g., 110A, 110N, etc.) and/or from the IN (140) (via the manager (127)), the distributed dedupe storage platform (120) may be configured to, e.g.,: (i) store encrypted and/or unencrypted data (e.g., store any information utilized by the clients and/or by the IN such as full and incremental backups) across multiple physical storage nodes/units (e.g., 125A, 125N, etc.), (ii) perform data encryption and decryption operations (using cryptographic keys as well as generating or otherwise obtaining and updating such keys), (iii) perform data compression and decompression operations across one or more storage nodes, (iv) perform automatic data deduplication operations on unencrypted data ((a) to identify and eliminate redundant data during, for example, a data backup process (only unique data segments may be stored and duplicates may be replaced with references to optimize storage space by iterating data stored in containers) and (b) with the remaining data/content packed into one or more compression regions (FIG. 4.2)) across one or more storage nodes, (v) service requests received from the clients (e.g., 110A, 110N, etc.) and/or the IN (140) to access data on the storage nodes (e.g., 125A, 125N, etc.); (vi) partition ingested data into discrete data chunks (e.g., segments, see FIG. 2) that are to be, for example, compared, identified as duplicate, and eventually removed (in which the partitioning may be performed with different granularity, using various criteria for data chunk boundaries as well as for their sizes); (vii) perform data synchronization and/or coordination among different storage nodes (e.g., 125A, 125N, etc.); (viii) store different types of data (e.g., files, data blocks, objects (where data may be wrapped into objects and identified by a unique identifier or a hash value)) that may be distributed across several computing devices (e.g., 125A, 125N, etc.); and/or (ix) provide high-performance and low-latency network access to one or more storage nodes (e.g., 125A, 125N, etc.) for users of a client (e.g., 110A, 110N, etc.) and/or the IN (140).

In one or more embodiments, a client (e.g., 110A, 110N, etc.) and/or the IN (140) may read and/or write data from/to memory and/or persistent storage device(s) (not shown) of one or more storage nodes (e.g., 125A, 125N, etc.) via an NVMe over fabric (NVMe-of) protocol, a remote direct memory access (RDMA) protocol, and/or a network file system (NFS) protocol. As a non-limiting example, a client (e.g., 110A, 110N, etc.) may execute connection software (not shown) that facilities a connection between the client and one or more storage endpoint(s) (e.g., a storage target, a storage node (e.g., 125A)) over the network (130). The storage node may persist data on NVMe storage devices (not shown) in which the client may execute connection software that is configured to connect to and access the NVMe storage devices of the storage node.

In one or more embodiments, a storage node (e.g., 125A, 125N, etc.) may be a computing device that, at least, executes software configured to handle (read and/or write) data in memory and/or physical storage device(s) of the storage node. Data stored to one or more storage device(s) across one or more storage node(s) (e.g., 125A, 125N, etc.) may be logically grouped into one or more storage volume(s) (not shown).

In one or more embodiments, a storage volume may be a logical storage structure that stores data for use by one or more clients (e.g., 110A, 110N, etc.) and/or the IN (140). A storage volume may be allocated (i) across one entire physical storage device, (ii) on a portion of one physical storage device, (iii) across two or more physical storage devices, (iv) across two or more portions of two or more physical storage devices, and/or (v) any combination thereof.

Further, in one or more embodiments, when a storage volume persists across two or more physical storage devices, those storage devices may be located in two or more storage nodes (e.g., 125A, 125N, etc.). Accordingly, a storage volume may provide a logical namespace that acts as a layer of indirection between software utilizing data and the data itself (e.g., software executing on a client (e.g., 110A) and the underlying physical storage devices located across one or more storage nodes (e.g., 125A, 125N, etc.)). Non-limiting examples of a storage volume may include an NVMe namespace, an NFS share, a redundant array of independent disks (RAID) array, etc.

In one or more embodiments, a storage node (e.g., 125A, 125N, etc.) may provide long-term, durable, high read/write throughput data storage/protection with near-infinite scale and low-cost. The storage node may be a fully managed cloud/remote (or local) storage (e.g., pluggable storage, object storage, block storage, file system storage, data stream storage, Web servers, unstructured storage, etc.) that acts as a shared storage/memory resource that is functional to store unstructured and/or structured data. In one or more embodiments, the storage node may include any quantity and/or combination of memory devices (i.e., volatile storage), long-term storage devices (i.e., persistent storage), other types of hardware devices that may provide short-term and/or long-term data storage services, and/or logical storage devices (e.g., virtual persistent storage/virtual volatile storage).

For example, the storage node (e.g., 125A, 125N, etc.) may include a memory device (e.g., a dual in-line memory device), in which data is stored and from which copies of previously stored data are provided. As yet another example, the storage node may include a persistent storage device (e.g., an SSD), in which data is stored and from which copies of previously stored data is provided. As yet another example, the storage node may include (i) a memory device in which data is stored and from which copies of previously stored data are provided and (ii) a persistent storage device that stores a copy of the data stored in the memory device (e.g., to provide a copy of the data in the event that power loss or other issues with the memory device that may impact its ability to maintain the copy of the data).

In one or more embodiments, unstructured and/or structured data (stored by a storage node (e.g., 125A)) may be updated (automatically) by the manager (127) when, for example, (but not limited to): newer system logs are received, a health state of a client (e.g., 110A) is changed, etc.

In one or more embodiments, through different types of virtualization, the distributed dedupe storage platform (120) (via the manager (127)) may present one or more storage nodes (e.g., 125A, 125N, etc.), for example, to a client (e.g., 110A, 110N, etc.) such that the storage nodes appear to be locally attached, ensuring the highest simultaneous access speed available for media and mission critical stored data.

Further, the distributed dedupe storage platform (120) may be used to, for example (but not limited to): improve application (and/or data) availability (e.g., via multiple data paths, internal fallback (e.g., hardware redundancy) mechanisms, etc.), enhance application performance of the clients (e.g., 110A, 110N, etc.) and/or the IN (140) (e.g., via off-load storage functions, segregate networks, etc.), increase storage utilization and effectiveness (e.g., by consolidating storage resources, providing tiered storage, etc.), etc.

As discussed above, the distributed dedupe storage platform (120) may provide data protection (e.g., data backup, data replication, data management, data restore, etc.) services to the clients (e.g., 110A, 110N, etc.) (or any other component of the system (100)) via the manager (127). The data protection services may initiate generation and storage of backups (e.g., block-based backups, file-based backups, etc.) in one or more storage nodes (e.g., 125A, 125N, etc.). The data protection services may also include restoration of, for example, the clients (e.g., 110A, 110N, etc.) (or any other component of the system (100)) to a restoration node (not shown) using the backups stored (temporarily or permanently) in the storage nodes.

Turning now to the manager (127), the manager (127) (e.g., a storage platform manager) may be a computing device that manages (e.g., creates, monitors, facilitates, modifies, removes, etc.), at least, one or more storage nodes (e.g., 125A, 125N, etc.), one or more storage volumes, and/or the connections among the storage nodes and the clients (e.g., 110A, 110N, etc.).

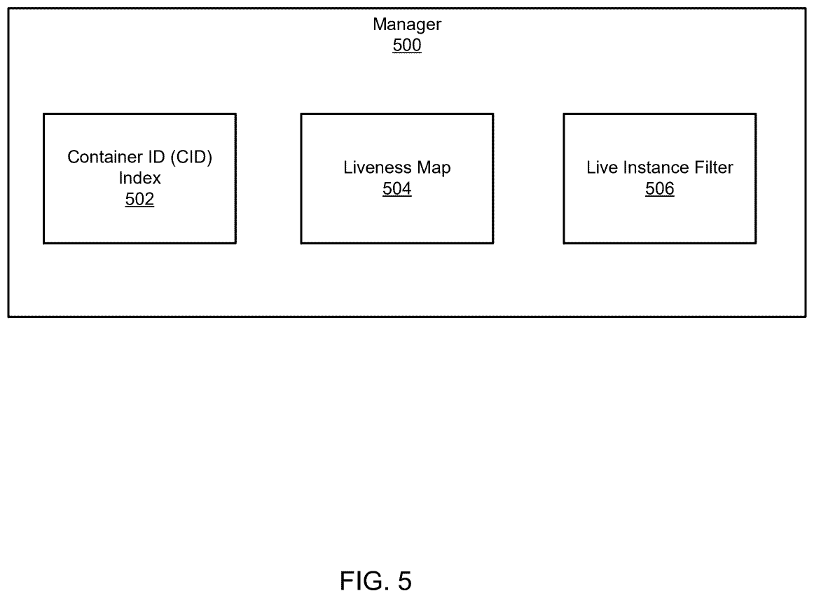

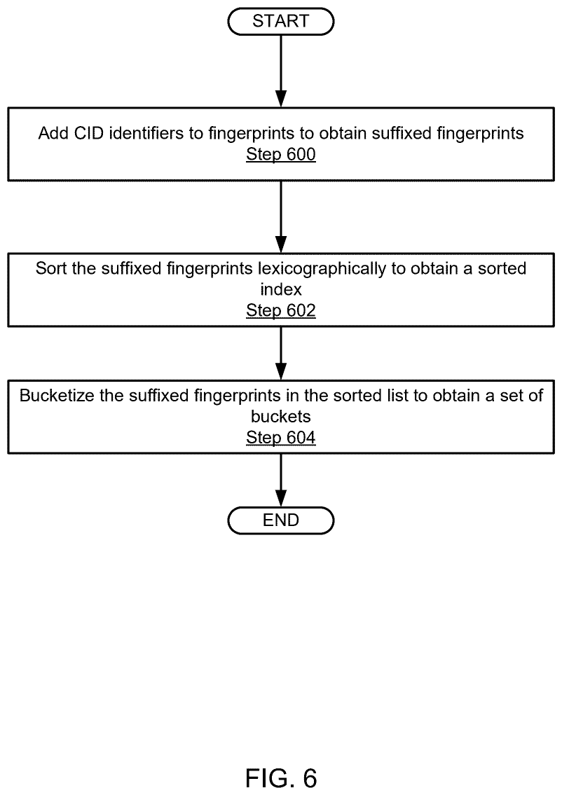

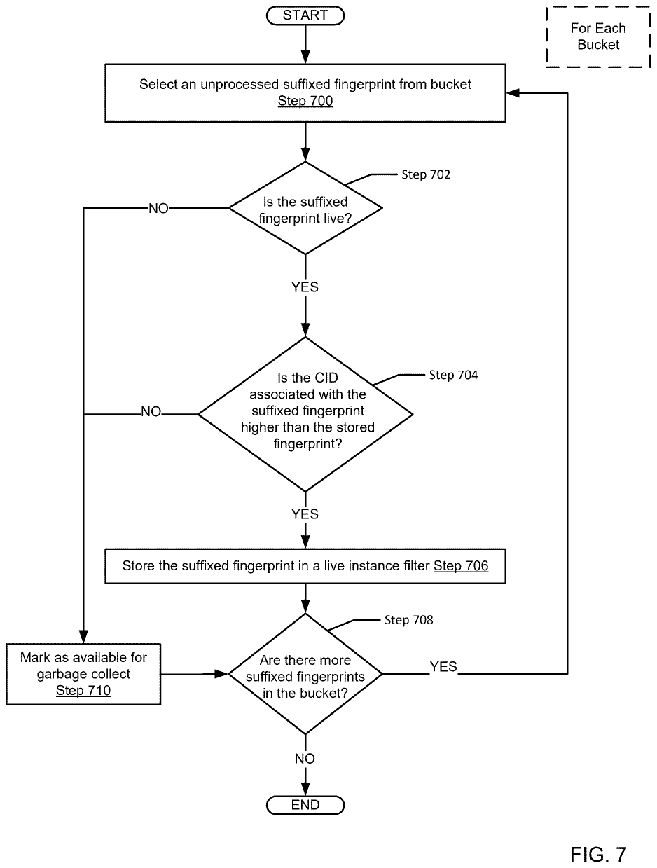

In one or more embodiments, the manager (127) may include the functionality to manage (e.g., create, monitor, facilitate, modify, remove, etc.) containers within one or more storage nodes (e.g., 125A, 125N, etc.). Additional detail about the manager is described in FIG. 5. One of ordinary skill will appreciate that the manager (127) may perform other functionalities without departing from the scope of the embodiments disclosed herein. In one or more embodiments, the manager (127) may be configured to perform all, or a portion, of the functionalities described in FIGS. 6 and 7. The manager (127) may be implemented using hardware (e.g., any number of integrated circuits for processing computer readable instructions), software (e.g., a computer program), or any combination thereof.

In one or more embodiments, all, or a portion, of the components of the system (100) may be operably connected each other and/or other entities via any combination of wired and/or wireless connections. For example, the aforementioned components may be operably connected, at least in part, via the network (130). Further, all, or a portion, of the components of the system (100) may interact with one another using any combination of wired and/or wireless communication protocols.

In one or more embodiments, the network (130) may represent a (decentralized or distributed) computing network and/or fabric configured for computing resource and/or messages exchange among registered computing devices (e.g., the clients, the IN, the storage nodes, etc.). As discussed above, components of the system (100) may operatively connect to one another through the network (e.g., a storage area network (SAN), a personal area network (PAN), a LAN, a metropolitan area network (MAN), a WAN, a mobile network, a wireless LAN (WLAN), a virtual private network (VPN), an intranet, the Internet, etc.), which facilitates the communication of signals, data, and/or messages. In one or more embodiments, the network (130) may be implemented using any combination of wired and/or wireless network topologies, and the network may be operably connected to the Internet or other networks. Further, the network (130) may enable interactions between, for example, the clients and the IN through any number and type of wired and/or wireless network protocols (e.g., TCP, UDP, IPv4, etc.).

The network (130) may encompass various interconnected, network-enabled subcomponents (not shown) (e.g., switches, routers, gateways, cables etc.) that may facilitate communications between the components of the system (100). In one or more embodiments, the network-enabled subcomponents may be capable of: (i) performing one or more communication schemes (e.g., IP communications, Ethernet communications, etc.), (ii) being configured by one or more components in the network, and (iii) limiting communication(s) on a granular level (e.g., on a per-port level, on a per-sending device level, etc.). The network (130) and its subcomponents may be implemented using hardware, software, or any combination thereof.

While FIG. 1 shows a configuration of components, other system configurations may be used without departing from the scope of the embodiments disclosed herein.

Turning now to FIG. 2, FIG. 2 shows an example segment tree in accordance with one or more embodiments disclosed herein. The example, illustrated in FIG. 2 and described below, is for explanatory purposes only and not intended to limit the scope disclosed herein.

In one or more embodiments, the example segment tree may include, for example (but not limited to): one or more data segments (e.g., each data segment may be around 8 kilobytes (KB) in size), one or more metadata segments (e.g., each metadata segment may be around 4KB in size), a namespace (e.g., a file handle, a content handle, etc.) of a file, etc.

In one or more embodiments, incoming user data (to the distributed dedupe storage platform (e.g., 120, FIG. 1)) may be segmented into variable size segments (by the manager (e.g., 127, FIG. 1)) on an average between 4KB to 12KB, with 8KB segments being a useful average. More specifically, the manager may divide (or break) incoming storage objects (e.g., assets/data that are often compound storage objects including many individual storage objects) into one or more data chunks (e.g., segments, storage objects, etc.). Further, the manager (e.g., 127, FIG. 1) may generate a cryptographic hash value (e.g., a cryptographic fingerprint, a hash, etc.) for each segment using its hash calculation mechanism, for example, by employing a secure hash algorithm/model (e.g., SHA-1, SHA-256, etc.), in which, in the distributed dedupe storage platform (e.g., 120, FIG. 1), a fingerprint (of a segment) may be a 24-byte entity (e.g., a 24-byte message digest, a 24-byte reference, etc.) of an (average) 8KB segment. To this end, files in the distributed dedupe storage platform (e.g., 120, FIG. 1) may be represented with a tree of fingerprints.

In one or more embodiments, the manager (e.g., 127, FIG. 1) may maintain a “hash value lookup table” (e.g., a key-value table in the KVS (e.g., 135, FIG. 1)), as storage object information (e.g., data chunk to hash value metadata). The hash value lookup table may represent (or specify) an index (e.g., a deduplication index, a deduplication directory, etc., which is utilized in detecting duplicate data chunks) where the hash values for stored data chunks may be maintained in that index. For example, a hash value of a data chunk (as being a digital signature that uniquely identifies an associated data chunk) being considered may be looked-up in the hash value lookup table. If an entry is found for that hash value, then a redundant data chunk is identified, and that data chunk may be replaced with a pointer to the matching data chunk (e.g., a pointer to a single copy of the matching data chunk) maintained in a storage node (e.g., in a corresponding drive of the storage node). In this manner, the manager may only store non-redundant data chunks in the corresponding drive.

As indicated above, the hash value lookup table may be maintained by the manager (e.g., 127, FIG. 1). The manager may add, remove, and/or modify information included in the hash value lookup table. The manager may do so based on information or a request/call obtained from administrators, other data structures, and/or from other sources (e.g., the IN (e.g., 140, FIG. 1) ). The data structures of the hash value lookup table may be implemented using, for example, lists, tables, unstructured data, databases, etc. While described as being stored locally, the hash value lookup table (or various portions thereof) may be stored remotely and may be distributed across any number of devices (e.g., may be stored at alternative locations within the system (e.g., 100, FIG. 1)) without departing from the embodiments disclosed herein.

Referring to FIG. 2, with the help of the manager (e.g., 127, FIG. 1), a file system in the distributed dedupe storage platform (e.g., 120, FIG. 1. may use/implement a segregated architecture to store metadata and data (e.g., associated with files). For example, a file system of the distributed dedupe storage system (e.g., 120, FIG. 1) may use a segregated architecture to store metadata of files to the KVS (e.g., 135, FIG. 1) and to store the data of the files to one or more storage nodes of the distributed dedupe storage system.

In one or more embodiments, metadata may be a set of name-value pairs (and kept in corresponding metadata segments) that provides information about an object/file (e.g., time/date information when the file is last modified). In this “segment tree based file system”, files may be stored as the example segment tree (where the files may be associated with data and metadata such that the files may be associated with metadata segments and L0 segments (data segments)), in which (i) the lowest level of the tree (e.g., Level 0 (L0) A segment, L0 B segment, etc.) may be a hash of user data (e.g., data chunks directly written by a user may be called as “L0 data segments”) and (ii) the intermediate levels of the example segment tree (e.g., Level 1 (L1) segments (e.g., L1 A segment, L1 B segment, etc.), Level 2 (L2) segments (e.g., L2 A segment, L2 B segment, etc.), etc.) may be hashes of corresponding child nodes/segments (e.g., L1 A segment and L1 B segment may be referenced by a Level 2 (L2) segment).

More specifically, segments of user data (e.g., data segments, the data portion of the segment tree) may be called/assigned as L0 segments in the segment tree (and stored to a related storage node(s) (e.g., 125A, 125N, etc.)) and metadata segments (e.g., remaining segments of the segment tree) may be called as “Lp” segments (and stored to the KVS (e.g., 135, FIG. 1) as an index, where a “key” is a parent segment and a “value” is a child segment(s) hosted by the parent segment), in which “p” is a parameter that ranges from one to six (e.g., L1 through Level 6(L6)) and indicates metadata representing (or related to) a corresponding file. Said another way, (a) metadata segments of the segment tree may include segments from L6 of the segment tree to L1 of the segment tree, (b) the metadata segments of the segment tree may be stored to the KVS, and (c) a key in the KVS may represent a parent segment and a value associated with the key may represent a set of child segments hosted by the parent segment.

Referring to the distributed dedupe storage platform (e.g., 120, FIG. 1), levels may be from L1 through L6 (where the storage system may support generation of the metadata segments up to L6), in which L6 is the highest level of the segment tree (e.g., the root of the segment tree). When two or more L0 segments are accumulated, an L1 “parent” segment may be formed (e.g., L1 A segment may be a parent of L0 A and L0 B “child” segments, in which L1 A segment may comprise cryptographic hash values of L0 A and L0 B segments). When the number of L0 segments exceeds the span of a L1 parent segment (e.g., L1 A segment), a second L1 parent segment (e.g., L1 B segment) may be formed, at which point an L2 segment (e.g., L2 B segment) may be formed (as a parent to L1 A and L1 B “child” segments (where the parent includes (e.g., points to, references, etc.) a collection of child segments (or child message digests/fingerprints)), from the perspective of L2 B segment). This may keep occurring until the file is completely created (in the file system).

As indicated, all files (in the file system) may have an L6 segment (e.g., L6 A segment) as the top segment, which, in turn, can point/reference to any of the lower-level segments between L5 segments through L0 segments (depending on the size of a related file). Said another way, each file of the data may be represented with an L6 segment and corresponding lower level segments in the segment tree depending on a size of each file. However, (a) L5 segments (e.g., L5 A segment) may only point to Level 4 (L4) segments (e.g., L4 A segment, L4 B segment, etc.), (b) L4 segments (e.g., L4 A segment, L4 B segment, etc.) may only point to Level 3 (L3) segments (e.g., L3 A segment, L3 B segment, etc.), (c) L3 segments (e.g., L3 A segment, L3 B segment, etc.) may only point to L2 segments (e.g., L2 A segment, L2 B segment, etc.), (d) L2 segments (e.g., L2 A segment, L2 B segment, etc.) may only point to L1 segments (e.g., L1 A segment, L1 B segment, etc.), and (e) L1 segments (e.g., L1 A segment, L1 B segment, etc.) may only point to L0 segments (e.g., L0 A segment, L0 B segment, etc.).

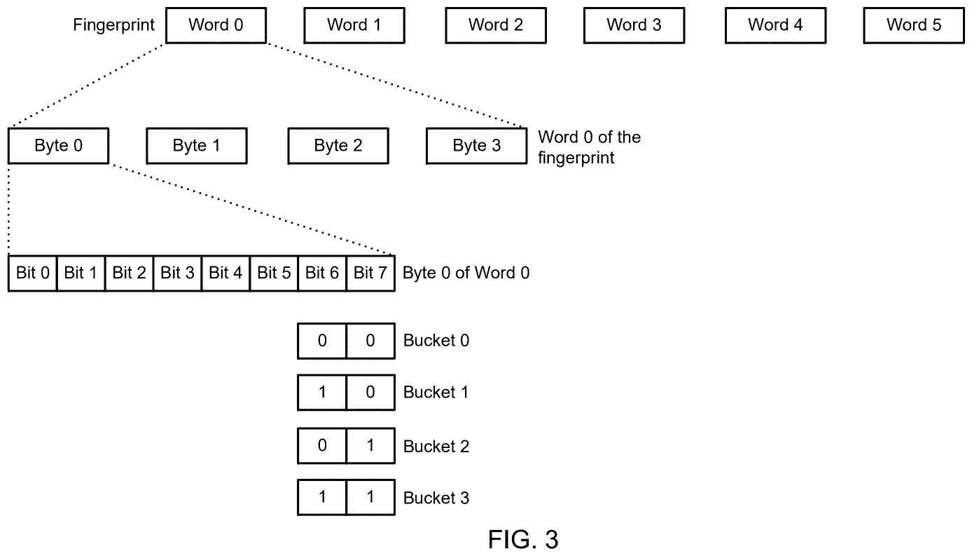

Turning now to FIG. 3, FIG. 3 shows an example segment dataset bucketization (e.g., for parallel processing) in accordance with one or more embodiments disclosed herein. The example, illustrated in FIG. 3 and described below, is for explanatory purposes only and not intended to limit the scope disclosed herein.

Referring to FIG. 3, contents of a segment may be represented by a 24-byte fingerprint, which constitutes a 20-byte fingerprint (e.g., a 20-byte SHA1 fingerprint) and 4-byte checksum. In one or more embodiments, contents of a data segment (e.g., L0 A segment) may be user data and contents of a metadata segment (e.g., L3 A segment) may be metadata (e.g., a hash value of hash values associated with L2 A segment and L2 B segment).

In one or more embodiments, the example segment dataset may be partitioned (by the manager (e.g., 127, FIG. 1)) using at least N (e.g., 2) bits of a related fingerprint to allow the generation of 2∧N buckets (e.g., Bucket 1, Bucket 2, Bucket 3, and Bucket 4). For example, a given fingerprint of an object may be a 20-byte SHA1 fingerprint, in which (i) the fingerprint may include five words (e.g., Word 0) Word 1, Word 2, Word 3, and Word 4) and (ii) each word (e.g., Word 0) may be formed based on four bytes (e.g., Byte 0, Byte 1, Byte 2, and Byte 3). Through segment dataset bucketization (or a bit-based bucketization) and depending on at least 2 bits (or depending on the combination of at least bits (e.g., 00, 10, 01, and 11)) the fingerprints may be divided into buckets. For example, Byte 0 may be stored/mapped to Bucket 0 (and later retrieved from Bucket 0). Further, the buckets may be created using the last bit (e.g., bit 7) of the first byte (e.g., byte 0) of the first word (e.g., word 0) in the fingerprint. By assigning fingerprints (or suffixed fingerprints) to buckets using the last bit (e.g., bit 7) of the first byte (e.g., byte 0) of the first word (e.g., word 0) in the fingerprint, all identical fingerprints are assigned to the same bucket. Other methods for assigning the same fingerprints to the same bucket may be used without departing from the invention.

As used herein, a “bucket” is a logical structure that allows users to organize their data. For example, behind the scenes, the data may be distributed across two or more storage nodes (e.g., 125A, 125N, etc.) using buckets.

Turning now to FIG. 4.1, FIG. 4.1 shows a diagram of a container (400) in accordance with one or more embodiments disclosed herein.

In one or more embodiments, the container (400) includes any number of compression regions (e.g., compression region A (404A), compression region N (404N), etc.). The container (400) may include additional, fewer, and/or different components without departing from the scope herein. Each component may be operably/operatively connected to any of the other components without departing from the scope of the embodiments disclosed herein. Each component illustrated in FIG. 4.1 is discussed below.

In one or more embodiments, each compression region (404A, 404N) includes segments, where the segments are stored in a compressed form. This allows for reducing the overall data size while maintaining the original information. As a non-limiting example, the compression region may contain compression data associated with live and/or dead segments within the distributed dedupe file system. In one or more embodiments, the compression region (404) may be formed using compression algorithms that analyze data to find recurring patterns or sequences. In one or more embodiments, the compression region (404) may comprise of lossless compression or lossy compression. As used herein, lossless compression is where the original data can be perfectly reconstructed from the compressed data. As used herein, lossy compression is where the compressed region may discard some information to further reduce the size of the data stored, potentially impacting data quality.

In one or more embodiments, each container (400) is associated with container metadata (not shown). The container metadata specifies the container with which it is associated using, e.g., a container identifier (CID). Further, the container metadata includes a set of fingerprints, where each of the fingerprints corresponds to a segment in the corresponding container. In this manner, the container metadata may be used to determine which segments are stored in which containers. In one or more embodiments, the container metadata (402) may be stored in the KVS (135).

Turning now to FIG. 4.2, FIG. 4.2 shows a diagram of a compression region in accordance with one or more embodiments disclosed herein. In one or more embodiments, the compression region (410) comprises any number of segments (e.g., segment L0 (412A), segment LN (412N), etc.) which are described above. The compression region (410) may include additional, fewer, and/or different components without departing from the scope herein. Each component may be operably/operatively connected to any of the other components without departing from the scope of the embodiments disclosed herein.

Turning now to FIG. 5, FIG. 5 shows a diagram of a manager in accordance with one or more embodiments disclosed herein. In one or more embodiments, the manager (500) comprises a container identification (CID) index (502), a liveness map (504), and a live instance filter (506). The manager (500) may include additional, fewer, and/or different components without departing from the scope herein. Each component illustrated in FIG. 5 is discussed below.

In one or more embodiments, the CID index (502) tracks which fingerprints (which may be suffixed fingerprints) are associated with each container.

In one or more embodiments, the liveness map (504) tracks which fingerprints (and by extension which segments) are live. A fingerprint is deemed to be live when at least one other fingerprint references (or otherwise points to) the fingerprint.

In one or more embodiments, the live instance filter (506) tracks the most recent copy of the live fingerprint in the container. As a non-limiting example, the liveness map may identify suffixed fingerprints FP1: 100, FP1: 120, and FP1: 130 as live. FP denotes fingerprints and 100, 120, and 130 denote the containers. Container 130 is the container which contains the most recent data and accordingly receives the highest CID number (e.g., 130). In this non-limiting example, the three listed fingerprints are all the same fingerprint, FP1, located in three different containers. The live instance filter stores FP1: 130 as the most recent fingerprint. The other two versions of FP1 are marked as dead because they are duplications of FP1: 130.

FIGS. 6 and 7 show a method for identifying live segments in a storage system (e.g., the distributed dedupe storage platform (e.g., 120, FIG. 1)) in accordance with one or more embodiments disclosed herein. While various steps in the method are presented and described sequentially, those skilled in the art will appreciate that some or all of the steps may be executed in different orders, may be combined or omitted, and some or all steps may be executed in parallel without departing from the scope of the embodiments disclosed herein.

Turning now to FIG. 6, the method shown in FIG. 6 may be executed by, for example, the above-discussed manager (e.g., 127, FIG. 1) (in conjunction with processors of corresponding storage nodes (e.g., 125A, 125N, FIG. 1)). Other components of the system (100) illustrated in FIG. 1 may also execute all or part of the method shown in FIG. 6 without departing from the scope of the embodiments disclosed herein.

In Step 600, the manager adds CID identifiers to fingerprints to obtain suffixed fingerprints. More specifically, for each fingerprint, the CID of the container in which it is located is added to the fingerprint (e.g., FP1:120) to obtain suffixed fingerprints. In Step 602, the manager sorts the suffixed fingerprints first lexicographically on the fingerprint and then descending order on the CID to obtain a sorted index.

Lexicographical sorting arranges elements in a sequence based on their character order, as if they were listed in a dictionary. For numbers stored as strings, sorting is done character by character from left to right, so shorter strings or numbers with smaller leading digits come first. For example, [FP1, FP6, FP5, FP2] would be stored as [FP1, FP2, FP5, FP6].

As discussed above, the suffixed fingerprints are stored first lexicographically and then in descending CID order. This results in all versions of the same fingerprint to be clustered together and then internally sorted based on their CIDs. For example, [FP1:110, FP6:120, FP1:120, FP5:110, FP2:140, FP2:120] would be sorted as [FP1:120, FP1:110, FP 2:140, FP 2:120, FP 5:110, FP 6:120].

Continuing with the discussion of FIG. 6, in Step 604, the manager bucketizes the suffixed fingerprints in the sorted list to obtain a set of buckets. The buckets naturally sort into 2∧N groupings as described above and allow for parallel processing where the fingerprints fall evenly into the 2∧N buckets. In one embodiment, the bucketization process ensures that all identical fingerprints are located in the same bucket. Said another way, different copies of the same fingerprint cannot be stored in multiple buckets.

Turning now to FIG. 7, the method shown in FIG. 7 may be executed by, for example, the above-discussed manager (e.g., 127, FIG. 1) (in conjunction with processors of corresponding storage nodes (e.g., 125A, 125N, FIG. 1)). The method shown in FIG. 7 occurs for each bucket in parallel. Accordingly, this method may be memory constrained and the number of buckets processed may be dependent on the processing power of the computing device (FIG. 9). Other components of the system (100) illustrated in FIG. 1 may also execute all or part of the method shown in FIG. 7 without departing from the scope of the embodiments disclosed herein.

In Step 700, the manager selects an unprocessed suffixed fingerprint from the bucket, wherein the bucket is a bucket in the set of buckets created in FIG. 6. In Step 702, a determination is made if the suffixed fingerprint is live. If the fingerprint is determined to be live, the method continues to step 704. If the fingerprint is determined to be dead, the method proceeds to step 710.

In Step 704, a determination is made if the CID associated with the suffixed fingerprint is numerically higher (or greater) than a stored fingerprint in the live instance filter. In one or more embodiments, the live instance filter may not have a stored CID and the determination will return YES and proceed to step 706. If the CID is higher than the stored fingerprint in the live instance filter, then the method also proceeds to step 706. If the determination made finds that the CID associated with the suffixed fingerprint is not higher than the stored fingerprint in the live instance filter, the method proceeds to step 710.

In Step 706, based on the determination above, the suffixed fingerprint with the higher CID count is stored in a live instance filter, either replacing the previously stored suffixed fingerprint or becoming the first stored suffixed fingerprint in the live instance filter. In Step 708, a determination is made about whether there are more suffixed fingerprints in the bucket to process. If the determination is YES, the method returns to step 700. If the determination is NO, the method ends.

In Step 710, suffixed fingerprint is marked as available for garbage collection and is eventually cleaned up by the manager. As used herein, clean up refers to removing the suffixed fingerprint from the container to reduce/reclaim consumed resources and efficiently use memory in the storage.

### EXAMPLE

The following shows a non-limiting example in accordance with one or more embodiments. The example is not intended to limit the scope of the claims.

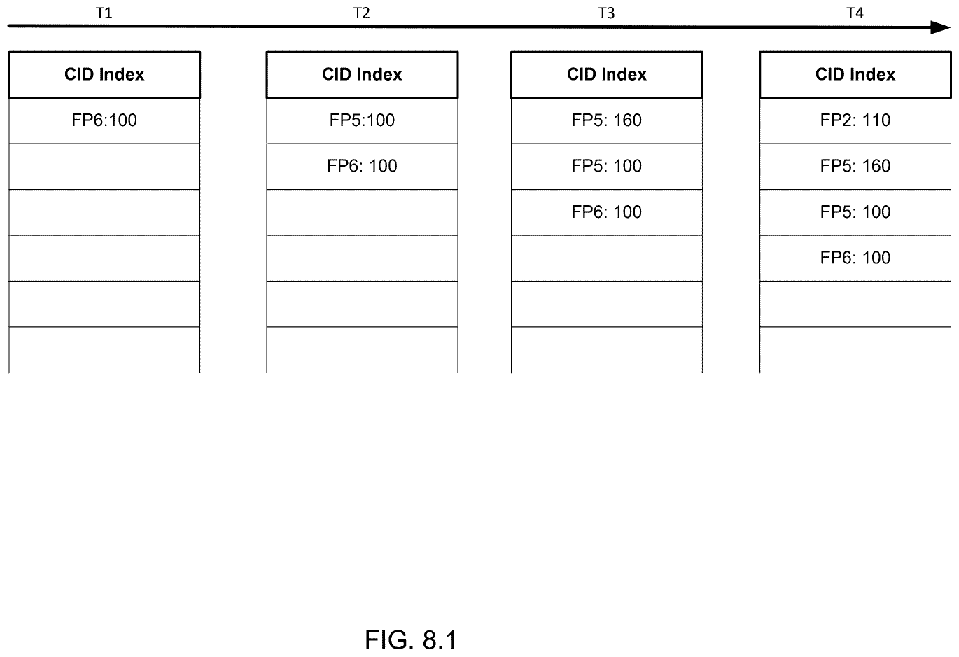

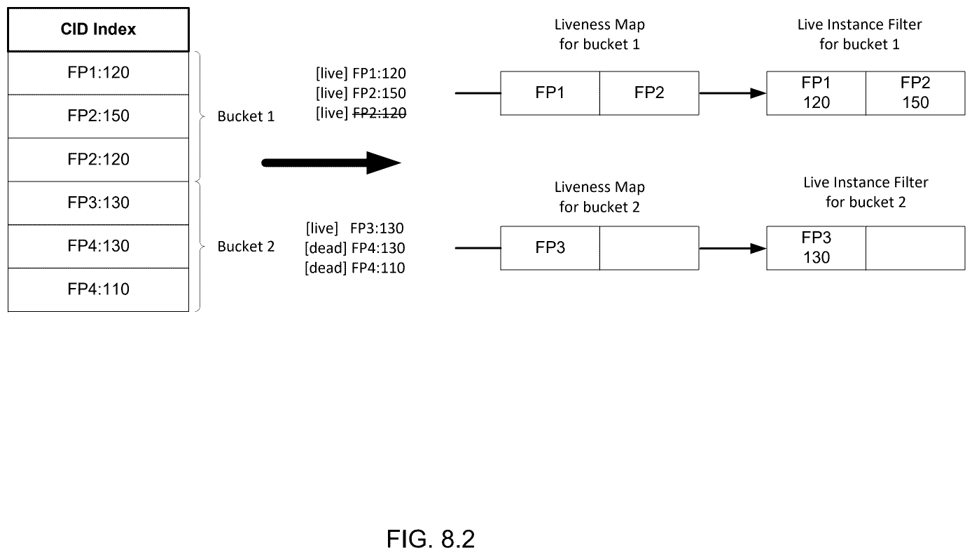

Turning to FIG. 8.1, FIG. 8.1 shows an example of lexicographical sorting in accordance with one or more embodiments disclosed herein. The example contains a depiction of sorting suffixed fingerprints associated with multiple containers into a CID Index. The example progresses chronologically from time 1(T1 ) to time 4(T4 ). At T1, the CID index comprises one suffixed fingerprint, FP6:100. As no more suffixed fingerprints are present, FP6:100 is added to the top of the index. At T2, the CID index receives an additional suffixed fingerprint, FP5:100. The CID index then sorts the two suffixed fingerprints, as shown, so that FP5:100 is above FP6:100. At T3, the CID index receives another fingerprint, FP5:160. FP5:160 is sorted above FP6:100 due to the lexicographical sorting methodology used by the CID index. Further, because there is another instance of FP5 (i.e., FP5:100), the placement of FP5:160 is based on the CID associated with each instance of FP5. Accordingly, FP 5:160 is sorted above FP5:100. At T4, the CID index receives another fingerprint, FP2:110, and sorts the fingerprint into the index as shown. The final index list is, in descending order, FP2:110, FP5:160, FP5:100, FP6:100. The example ends here.

Turning to FIG. 8.2, FIG. 8.2 shows an example of liveness filtering in accordance with one or more embodiments disclosed herein. The example contains a depiction of a CID index (created in FIG. 8.1), a liveness map, and a live instance filter. The example further contains the data flow from the index, the liveness map, and the live instance filter. Additionally, the example contains a depiction of the parallel processing used to batch process the fingerprints.

In the example, the CID index is divided into two buckets of fingerprints that are processed in parallel. Bucket 1 comprises FP1:120, FP2:150, and FP2:120. Bucket 2 comprises FP3:130, FP4:130, and FP4:110. The manager, not shown in this example, initializes two memory segments to process the fingerprints in each bucket as the buckets. At the same time, the manager initializes the same amount of memory for the live instance filter.

In the example, the liveness map check for the liveness of the fingerprints contained in the buckets. Here, the process for bucket 1 will be described but both bucket 1 and bucket 2 are processed in parallel in one or more embodiments.

The liveness map specifies that all three fingerprints in bucket 1 are live and adds the fingerprints to the live filter. Those skilled in the art will appreciate that any known or later discovered method for determining whether a fingerprint is live may be used without departing from the invention. Continuing with the discussion of FIG. 8.2, the manager uses the liveness map to populate the live instance filter. More specifically, the manager, in accordance with FIG. 7, to determine whether or not to mark each of the suffixed fingerprints in each bucket as dead. In bucket 1, the manager process fingerprints FP1: 120, FP2:150, and FP2:120. For FP1: 120, the manager uses the liveness map to determine that FP1 is live, and then checks the live instance filter to determine any version of FP1 is stored therein. In this example, because no version of FP1 is stored in the live instance filter, the manager stores FP1:120 in the live instance filter.

The manager then uses the liveness map to determine that FP2 is live, and then checks the live instance filter to determine any version of FP2 is stored therein. In this example, because no version of FP2 is stored in the live instance filter, the manager stores FP2:150 in the live instance filter.

Finally, the live instance filter iterates the last fingerprint in the index, FP2:120. The manager uses the liveness map to determine that FP2 is live, and then checks the live instance filter to determine any version of FP2 is stored therein. In this example, because there is a version of FP2 stored in the live instance filter, the manager does not store FP2:120 in the live instance filter; instead, the manager marks the suffixed fingerprint, FP2:150, as dead and available for garbage collection. The suffixed fingerprints in bucket 2 are processed in the same manner as bucket 1. This results in FP4:130 and FP4:110 both being marked as available for garbage collection.

### END OF EXAMPLE

Turning now to FIG. 9, FIG. 9 shows a diagram of a computing device in accordance with one or more embodiments disclosed herein.

In one or more embodiments disclosed herein, the computing device (900) may include one or more computer processors (902), non-persistent storage (904) (e.g., volatile memory, such as RAM, cache memory), persistent storage (906) (e.g., a non-transitory computer readable medium, a hard disk, an optical drive such as a CD drive or a DVD drive, a Flash memory, etc.), a communication interface (912) (e.g., Bluetooth interface, infrared interface, network interface, optical interface, etc.), an input device(s) (910), an output device(s) (908), and numerous other elements (not shown) and functionalities. Each of these components is described below.

In one or more embodiments, the computer processor(s) (902) may be an integrated circuit for processing instructions. For example, the computer processor(s) (902) may be one or more cores or micro-cores of a processor. The computing device (900) may also include one or more input devices (910), such as a touchscreen, keyboard, mouse, microphone, touchpad, electronic pen, or any other type of input device. Further, the communication interface (912) may include an integrated circuit for connecting the computing device (900) to a network (e.g., a LAN, a WAN, Internet, mobile network, etc.) and/or to another device, such as another computing device.

In one or more embodiments, the computing device (900) may include one or more output devices (908), such as a screen (e.g., a liquid crystal display (LCD), plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) (902), non-persistent storage (904), and persistent storage (906). Many different types of computing devices exist, and the aforementioned input and output device(s) may take other forms.

The problems discussed throughout this application should be understood as being examples of problems solved by embodiments described herein, and the various embodiments should not be limited to solving the same/similar problems. The disclosed embodiments are broadly applicable to address a range of problems beyond those discussed herein.

One or more embodiments disclosed herein may be implemented using instructions executed by one or more processors of a computing device. Further, such instructions may correspond to computer readable instructions that are stored on one or more non-transitory computer readable mediums.

While embodiments discussed herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for identifying dead segments for garbage collect, the method comprising:
selecting a suffixed fingerprint from a bucket;
making a first determination that the suffixed fingerprint is live using a live filter;
based on the first determining, making a second determination that a container identification number (CID) associated with the suffixed fingerprint is higher than a cached fingerprint in a live instance filter;
based on the second determining, replacing the cached fingerprint in the live instance filter with the suffixed fingerprint; and
marking everything not in the live instance filter as available for garbage collection.

2. The method of claim 1, wherein the suffixed fingerprint comprises a fingerprint and a container identifier (CID).

3. The method of claim 1, wherein the bucket containing the suffixed fingerprint is part of a plurality of buckets.

4. The method of claim 3, wherein the suffixed fingerprint is bucketized by selecting the last N bytes in the first letter of the first word.

5. The method of claim 3,
wherein each of the plurality of buckets contains a subset of suffixed fingerprints from a sorted index,
wherein the suffixed fingerprints each comprise a fingerprint and a container identifier (CID),
wherein each of the suffixed fingerprints are lexicographically sorted based on the fingerprint and when there are multiple suffixed fingerprints that have the same fingerprint, the multiple suffixed fingerprints are stored in a numerically descending order based on the CIDs.

6. The method of claim 1, wherein the live filter is a quotient filter.

7. The method of claim 1, wherein the live filter is a bloom filter.

8. A non-transitory computer readable medium comprising computer readable program code, which when executed by a computer processor enables the computer processor to perform a method for managing data in a storage system, the method comprising:
selecting a suffixed fingerprint from a bucket;
making a first determination that the suffixed fingerprint is live using a live filter;
based on the first determining, making a second determination that a container identification number (CID) associated with the suffixed fingerprint is higher than a cached fingerprint in a live instance filter;
based on the second determining, replacing the cached fingerprint in the live instance filter with the suffixed fingerprint; and
marking everything not in the live instance filter as available for garbage collection.

9. The non-transitory computer readable medium of claim 8, wherein the suffixed fingerprint comprises a fingerprint and a CID.

10. The non-transitory computer readable medium of claim 8, wherein the bucket containing the suffixed fingerprint is part of a plurality of buckets.

11. The non-transitory computer readable medium of claim 10, wherein the suffixed fingerprint is bucketized by selecting the last N bytes in the first letter of the first word.

12. The non-transitory computer readable medium of claim 10,
wherein each of the plurality of buckets contains a subset of suffixed fingerprints from a sorted index,
wherein the suffixed fingerprints each comprise a fingerprint and a container identifier (CID),
wherein each of the suffixed fingerprints are lexicographically sorted based on the fingerprint and when there are multiple suffixed fingerprints that have the same fingerprint, the multiple suffixed fingerprints are stored in a numerically descending order based on the CIDs.

13. The non-transitory computer readable medium of claim 8, wherein the live filter is a quotient filter.

14. The non-transitory computer readable medium of claim 8, wherein the live filter is a bloom filter.

15. A system for managing data in a storage system, the system comprising:
a processor comprising circuitry;
memory comprising instructions, which when executed by the processor perform a method, the method comprising:
selecting a suffixed fingerprint from a bucket;
making a first determination that the suffixed fingerprint is live using a live filter;
based on the first determining, making a second determination that a container identification number (CID) associated with the suffixed fingerprint is higher than a cached fingerprint in a live instance filter;
based on the second determining, replacing the cached fingerprint in the live instance filter with the suffixed fingerprint; and
marking everything not in the live instance filter as available for garbage collect.

16. The system of claim 15, wherein the suffixed fingerprint comprises a fingerprint and a CID.

17. The system of claim 15, wherein the bucket containing the suffixed fingerprint is part of a plurality of buckets.

18. The system of claim 17, wherein the suffixed fingerprint is bucketized by selecting the last N bytes in the first letter of the first word.

19. The system of claim 17,
wherein each of the plurality of buckets contains a subset of suffixed fingerprints from a sorted index,
wherein the suffixed fingerprints each comprise a fingerprint and a container identifier (CID),
wherein each of the suffixed fingerprints are lexicographically sorted based on the fingerprint and when there are multiple suffixed fingerprints that have the same fingerprint, the multiple suffixed fingerprints are stored in a numerically descending order based on the CIDs.

20. The system of claim 15, wherein the live filter is a quotient filter.
